(19) United States
(12) Patent Application Publication
(10) Pub. No.: US 2013/0259272 A1
(43) Pub. Date: Oct. 3, 2013

(54) Damper of a Voice Coil Plate for a Plate Speaker

(71) Applicant: Dong-Man Kim, Seoul-si (KR)

(72) Inventor: Dong-Man Kim, Seoul-si (KR)

(73) Assignee: EXCELWAY INC., Seoul-si (KR)

(21) Appl. No.: 13/989,485

(22) PCT Filed: Nov. 11, 2011
(86) PCT No.: PCT/KR2011/008610

§ 371 Date: Jun. 14, 2013

(30) Foreign Application Priority Data
Nov. 29, 2010 (KR) 10-2010-0119430

(51) Int. Cl. H04R 9/06

(52) U.S. Cl. CPC H04R 9/06
USPC 381/162

(57) ABSTRACT

The present invention relates to a plate speaker, and more particularly, to a guide damper intended for a plate speaker and made of a flexible synthetic resin material. The guide damper for a voice coil plate for a plate speaker includes: a coil plate bonding part made of a flexible synthetic resin material and having an integrated structure, wherein the coil plate bonding part has a groove in the lengthwise direction thereof such that the voice coil plate is seated on the central portion thereof; an outer frame having a closed loop shape and adhering to a base frame defining the outer shape of the plate speaker, wherein the outer frame defines the outer shape of the damper; and a damper bridge connecting each of the left and right sides of the coil plate bonding part to the outer frame, wherein the damper bridge provides damping between the coil plate bonding part and the outer frame.

### TECHNICAL FIELD

The present invention relates to a plate type speaker, and more specifically, to a guide damper for a plate type speaker made of a flexible synthetic resin.

### BACKGROUND ART

A speaker has a voice coil and a diaphragm interposed between magnets and generates a sound as the diaphragm vibrates by the movement of the voice coil.

A plate type speaker has a plate voice coil and magnets arranged at both sides of the voice coil with a predetermined space, and an induced electromotive force is generated by the Fleming's left hand rule and the Lorentz rule to form a frequency corresponding to a voice and reproduce the sound by vibrating the diaphragm using the frequency.

The voice coil is spirally wound or printed as a pattern in an oval shape on one side or both sides of a coil base of a plate shape so as to form a voice coil plate.

The diaphragm is attached on the top of the voice coil plate in the lengthwise direction, and a sound is generated as the diaphragm vibrates according to the movement of the voice coil plate.

A guide damper is used to transfer the vibration from the voice coil plate to the diaphragm, and a damper covered with a piece of thin cloth or made of a metal material is used as the guide damper in the prior art.

In the plate type speaker, although the structure of the voice coil is important to efficiently transfer sound energies, damper capability of the guide damper, which is a medium for transferring the energies, is very important. For this reason, development of the guide damper is still under progress and advanced until present.

### DISCLOSURE OF INVENTION

### Technical Problem

Therefore, the present invention has been made in view of the above problems, and it is an object of the present invention to provide a damper made of a flexible rubber material, which can transfer further more sound energies to a diaphragm through a voice coil plate.

Another object of the present invention is to provide a damper made of a rubber material, which can lower manufacturing cost by manufacturing the damper as an integrated mold product, adhere the voice coil plate and the damper further easily, and strengthen adhesive force of the voice coil plate and the damper.

### Technical Solution

To accomplish the above objects, according to one aspect of the present invention, there is provided a guide damper of a voice coil plate for a plate type speaker, including: a coil plate bonding part made of a flexible synthetic resin material, having an integrated structure, and including a groove of a lengthwise direction formed at a central portion thereof so that the voice coil plate may be seated and bonded; an outer frame adhered on a base frame defining an outer appearance of the plate type speaker and formed in a closed loop shape configuring an outer appearance of the damper; and a damper bridge for connecting left and right sides of the coil plate bonding part to the outer frame and in charge of damping between the coil plate bonding part and the outer frame.

Here, preferably, the damper bridge has a predetermined width and includes a wrinkle part having wrinkles formed in a widthwise direction.

Here, preferably, the damper bridge is formed as many as three to five.

Here, preferably, the synthetic resin material is rubber.

### Advantageous Effects

According to the configuration of the present invention described above, there is provided a damper for a plate type speaker, which can transfer further more sound energies to a diaphragm through a voice coil plate, lower manufacturing cost by manufacturing the damper as an integrated mold product, adhere the voice coil plate and the damper further easily, and strengthen adhesive force of the voice coil plate and the damper.

### BRIEF DESCRIPTION OF THE DRAWINGS

FIG. 1 is an exploded perspective view showing a guide damper of a voice coil plate for a plate type speaker according to the present invention.

FIG. 2 is a perspective view showing a guide damper of a voice coil plate for a plate type speaker according to a first embodiment of the present invention.

FIG. 3 is a perspective view showing a guide damper of a voice coil plate for a plate type speaker according to a second embodiment of the present invention.

FIG. 4 is a perspective view showing a guide damper of a voice coil plate for a plate type speaker according to a third embodiment of the present invention.

### DESCRIPTION OF SYMBOLS

| | |
|---|---|
| 110: Voice coil plate | 111: Guide damper |
| 112: Yoke | 113: Magnet |
| 114: Magnetic body | 115: Diaphragm |
| 201, 301, 401: Coil plate bonding part | |
| 201a, 301a, 401a: Groove | |
| 201b, 301b, 401b: Wing | 202: Outer frame |
| 203a, 203b, 203c, 303a, 303b, 303c, 303d, 403a, | |
| 403b, 403c, 403d, 403e: Damper bridge | |

### BEST MODE FOR CARRYING OUT THE INVENTION

Hereinafter, the structure and operation effect of a guide damper of a voice coil plate for a plate type speaker will be described with reference to the accompanying drawings.

FIG. 1 is an exploded perspective view showing a guide damper of a voice coil plate for a plate type speaker according to the present invention.

As shown in FIG. 1, a plate type speaker according to the present invention includes a voice coil plate 110 having a voice coil spirally wound or printed as a pattern, a pair of magnetic bodies 114 spaced apart from each other by a predetermined distance on the left and right sides of the voice coil plate 110, a guide damper 111 combined on the bottom of the voice coil plate 110 to support vertical movement of the voice coil plate 110 and a diaphragm 115 combined on the top of the voice coil plate 110 to transfer vibration energies as a sound, and the plate type speaker may further include a base frame (not shown) of a synthetic resin material, which forms an outer appearance and combines various parts.

The magnetic body 114 may be configured in the form of combining a magnet 113 in the middle and yokes or magnetic plates 112 on the top and bottom of the magnet 113.

The plate type speaker of the present invention has the voice coil plate 110 and the magnetic bodies 114 arranged at both sides of the voice coil plate with a predetermined space, so that when a current flows through the voice coil, an induced electromotive force is generated by the Fleming's left hand rule and the Lorentz rule, and the voice coil plate 110 moves in the vertical direction by the induced electromotive force.

At this point, the guide damper 111 combined on the bottom of the voice coil plate 110 supports vertical movement of the voice coil plate 110 so that further more vibrations may be transferred to the diaphragm 115.

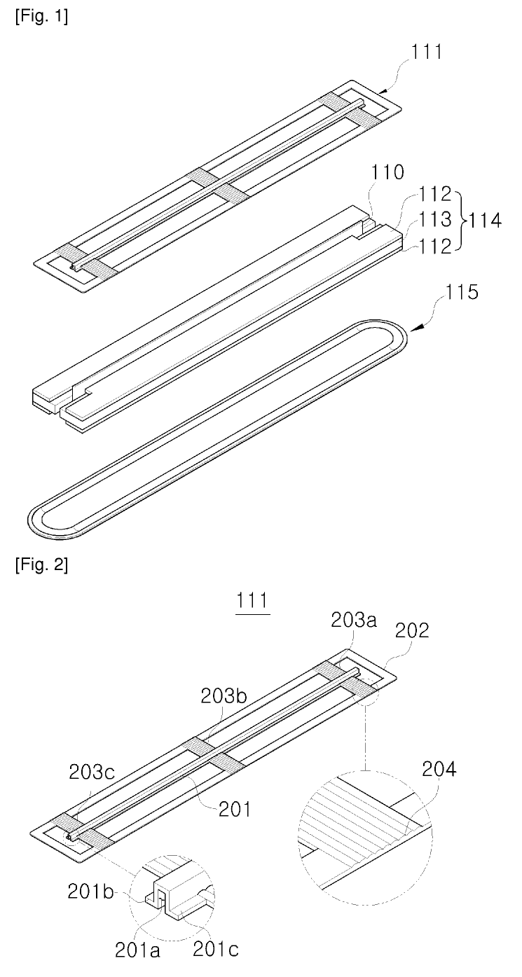

Hereinafter, the structure of the guide damper 111 desired to be implemented in the present invention will be described through the preferred embodiments shown in FIGS. 2 to 4.

The guide damper 111 of the first to third embodiments is combined on the bottom of the voice coil plate 110 and functions as a leaf spring or a damper working as a supporting means for transferring further more vibration energies to the diaphragm.

The guide damper 111 is made of a flexible synthetic resin material, preferably a rubber material, and may be manufactured as a mold product injection-molded in one piece.

[Guide Damper According a First Embodiment of the Present Invention]

FIG. 2 is a perspective view showing a guide damper of a voice coil plate for a plate type speaker according to a first embodiment of the present invention.

As shown in FIG. 2, the guide damper 111 is formed in a rectangular shape extended in the lengthwise direction and made of a rubber material molding a coil plate bonding part 201, an outer frame 202 and damper bridges 203a, 203b and 203c in one piece.

The coil plate bonding part 201 is formed in the lengthwise direction and has a groove 201a of a lengthwise direction formed at the central portion thereof so that the voice coil plate 110 may be seated and bonded, and wing parts 201b and 201c formed by extending both ends of the groove 201a.

The groove 201a of the coil plate bonding part 201 has a structure capable of maintaining the voice coil plate 110 to be positioned at the center and enhancing the bonding force.

The wing parts 201b and 201c function as a part for attaching the damper bridges 203a, 203b and 203c.

The outer frame 202 is a part adhered on the base frame (not shown) which defines an outer appearance of the plate type speaker and formed in a closed loop shape configuring the outer appearance of the guide damper 111.

The damper bridges 203a, 203b and 203c respectively connect the left and right sides of the coil plate bonding part 201 to the outer frame 202 and add damping force between the coil plate bonding part 201 and the outer frame 202.

In the first embodiment of the present invention, three damper bridges 203a, 203b and 203c respectively having left and right sides are formed in the middle and at both ends of the guide damper 111.

The damper bridges 203a, 203b and 203c may have a plurality of wrinkle parts 204 wrinkled in the widthwise direction in order to enhance damping strength and tensile strength. In addition, although it is not shown in the figure, a plurality of thin lead lines having a reduced width may be configured instead of the wrinkle parts 204 so that the plurality of thin lead lines may form a damper bridge.

[Guide Damper According a Second Embodiment of the Present Invention]

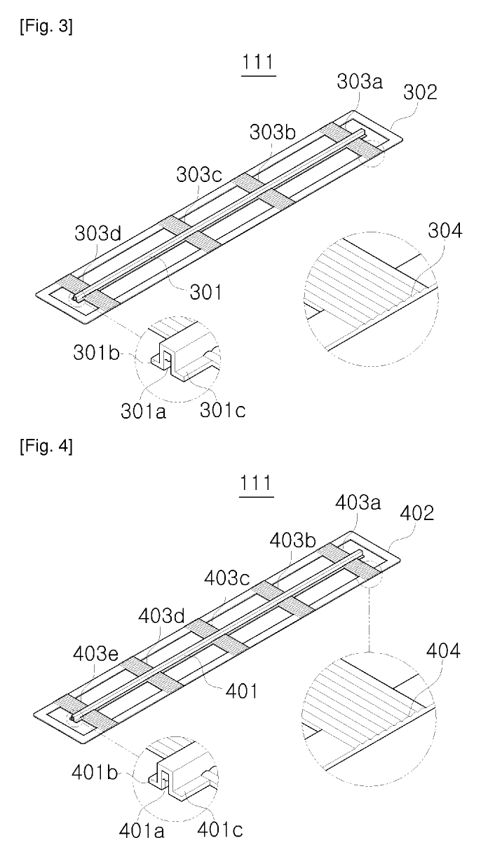

FIG. 3 is a perspective view showing a guide damper of a voice coil plate for a plate type speaker according to a second embodiment of the present invention.

The configuration of the second embodiment of the present invention is the same as that of the first embodiment except that a damper bridge is further added.

As shown in FIG. 3, the guide damper 111 is formed in a rectangular shape extended in the lengthwise direction and made of a rubber material molding a coil plate bonding part 301, an outer frame 302 and damper bridges 303a, 303b, 303c and 303d in one piece.

The coil plate bonding part 301 is formed in the lengthwise direction and has a groove 301a of a lengthwise direction formed at the central portion thereof so that the voice coil plate 110 may be seated and bonded, and wing parts 301b and 301c formed by extending both ends of the groove 301a.

The groove 301a of the coil plate bonding part 301 has a structure capable of maintaining the voice coil plate 110 to be positioned at the center and enhancing the bonding force.

The wing parts 301b and 301c function as a part for attaching the damper bridges 303a, 303b, 303c and 303d.

The outer frame 302 is a part adhered on the base frame (not shown) which defines an outer appearance of the plate type speaker and formed in a closed loop shape configuring the outer appearance of the guide damper 111.

The damper bridges 303a, 303b, 303c and 303d respectively connect the left and right sides of the coil plate bonding part 301 to the outer frame 302 and add damping force between the coil plate bonding part 301 and the outer frame 302.

The damper bridges 303a, 303b, 303c and 303d may have a plurality of wrinkle parts 304 wrinkled in the widthwise direction in order to enhance damping strength and tensile strength.

[Guide Damper According a Third Embodiment of the Present Invention]

FIG. 4 is a perspective view showing a guide damper of a voice coil plate for a plate type speaker according to a third embodiment of the present invention.

The configuration of the third embodiment of the present invention is the same as that of the first embodiment except that two damper bridges are further added.

As shown in FIG. 4, the guide damper 111 is formed in a rectangular shape extended in the lengthwise direction and made of a rubber material molding a coil plate bonding part 401, an outer frame 402 and damper bridges 403a, 403b, 403c, 403d and 403e in one piece.

The coil plate bonding part 401 is formed in the lengthwise direction and has a groove 401a of a lengthwise direction formed at the central portion thereof so that the voice coil plate 110 may be seated and bonded, and wing parts 401b and 401c formed by extending both ends of the groove 401a.

The groove 401a of the coil plate bonding part 401 has a structure capable of maintaining the voice coil plate 110 to be positioned at the center and enhancing the bonding force.

The wing parts 401b and 401c function as a part for attaching the damper bridges 403a, 403b, 403c, 403d and 403e.

The outer frame 402 is a part adhered on the base frame (not shown) which defines an outer appearance of the plate type speaker and formed in a closed loop shape configuring the outer appearance of the guide damper 111.

The damper bridges 403a, 403b, 403c, 403d and 403e respectively connect the left and right sides of the coil plate bonding part 401 to the outer frame 402 and add damping force between the coil plate bonding part 401 and the outer frame 402.

The damper bridges 403a, 403b, 403c, 403d and 403e may have a plurality of wrinkle parts 404 wrinkled in the widthwise direction in order to enhance damping strength and tensile strength.

The number of damper bridges used in the damper of the present invention described above may be correlated with the length of the plate type speaker, and it will not make a problem if one or more damper bridges are used. However, since the damping force may be excessively lowered if less than three damper bridges are used and damping capability may be lowered if five ore more damper bridges are used, it is preferable to maximize the damping force by installing three to five damper bridges as shown in the first to third embodiments of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A guide damper of a voice coil plate for a plate type speaker, the guide damper comprising:
a coil plate bonding part made of a flexible synthetic resin material, having an integrated structure, and including a groove of a lengthwise direction formed at a central portion thereof so that the voice coil plate may be seated and bonded;
an outer frame adhered on a base frame defining an outer appearance of the plate type speaker and formed in a closed loop shape configuring an outer appearance of the damper; and
a damper bridge for connecting left and right sides of the coil plate bonding part to the outer frame and in charge of damping between the coil plate bonding part and the outer frame.

2. The guide damper according to claim 1, wherein the damper bridge has a predetermined width and includes a wrinkle part having wrinkles formed in a widthwise direction.

3. The guide damper according to claim 1, wherein the damper bridge is formed as many as three to five.

4. The guide damper according to claim 1, wherein the synthetic resin material is rubber.
